(19) United States
(12) Patent Application Publication
(10) Pub. No.: US 2009/0050690 A1
(43) Pub. Date: Feb. 26, 2009

(54) ELECTRONIC MONEY SETTLING SYSTEM, AND ELECTRONIC MONEY SETTLING METHOD

(75) Inventor: Masayoshi Son, Tokyo (JP)

Correspondence Address: MAIER & MAIER, PLLC, 1000 DUKE STREET, ALEXANDRIA, VA, 22314, US

(73) Assignee: Softbank BB Corp., Minato-ku, Tokyo (JP)

(21) Appl. No.: 11/815,503

(22) PCT Filed: Feb. 2, 2006
(86) PCT No.: PCT/JP2006/301799

§ 371 Date: Dec. 27, 2007

(30) Foreign Application Priority Data
Feb. 4, 2005 (JP) 2005-061480

(51) Int. Cl. G06Q 40/00

(52) U.S. Cl. 235/379

(57) ABSTRACT

Electronic money is stored in a user card to be used by a user, and the sum of the electronic money stored in the user card is acquired by a shop terminal. In case this sum is smaller than a using sum for the settlement in question, the electronic money corresponding to the using sum is received, and the electronic money received is stored. The shop card is prestored with predetermined authentication information, and the electronic money is received/paid from/to the shop terminal only in case the authentication is completed by that authentication information. Thus, the off-line settlement with the electronic money can be made even under the circumstances such as an automatic vendor or an outdoor shop, when on-line facilities are hard to install.

### TECHNICAL FIELD

The present invention relates to a system and method for making the settlement of electronic money.

### BACKGROUND ART

In recent years, along with the IC implementation of credit cards and the growing popularity of electronic money, while electronic money is stored in mobile terminals and cards provided with IC tags which enable data transmission and reception through noncontact interfaces, there is increasing opportunity of making the settlement of electronic money, rather than payment in cash, by holding a card or mobile terminal over a reader device. Patent Document 1 discloses an example of such a system for making payment by electronic money.

In accordance with the technique disclosed in this Patent Document 1, a user can make payment with a user card he possesses in a member store such a convenience store. The member store completes the settlement by performing the authentication of the user card with a member store terminal device, reducing the amount of electronic money stored in the user card in correspondence with the using expense, and transmitting this usage history to an electronic money management server on the Internet. The electronic money management server performs calculation and settlement on the basis of the usage history and notifies the result to an issuer (institution that issues electronic money). The issuer collects and calculates the using sum of each member store, and controls the cash flow in order that the cash money corresponding to the using sum is transmitted to this each member store.

### Patent Document 1: Japanese Patent Published Application No. 2003-141428

### SUMMARY OF THE INVENTION

However, in accordance with the technique disclosed in the Patent Document 1 as described above, the member store terminal device must be provided inside of the store for accepting electronic money, and thereby it is required to provide an online facility for enabling the member store terminal device to communicate with the electronic money management server and connect the member store terminal device to the net.

However, for example in the case of an automatic vendor or an outdoor shop, it is difficult to install such an online facility, and thereby the electronic money technique as described above can sometimes not be available.

Taking into consideration the above circumstances, it is an object of the present invention to provide a system which makes it possible to make the settlement with electronic money even under the circumstances such as an automatic vendor or an outdoor shop where on-line facilities are hard to install.

In order to accomplish the object as described above, the present invention is related to an electronic money settling system for making settlement with electronic money, comprising: a user card operable to accumulate electronic money; a shop terminal operable to acquire the amount of electronic money stored in said user card, and accept the electronic money corresponding to the using sum associated with the settlement if the amount of electronic money stored in said user card is not greater than the using sum; and a shop card operable to store predetermined authentication information, and enable said shop terminal to deposit and withdraw electronic money only when the authentication is completed on the basis of the authentication information.

In accordance with the present invention as described above, electronic money is stored in a user card to be used by a user, and the amount of the electronic money stored in the user card is acquired by a shop terminal. If this amount is smaller than the using sum for the settlement in question, the electronic money corresponding to the using sum is received, and the electronic money received is stored. Then, predetermined authentication information is stored in the shop card, and the electronic money is deposited and withdrawn at the shop terminal only in case where the authentication is completed by that authentication information.

In accordance with the present invention as described above, when the user makes payment, it is determined only whether or not the balance of the user card exceeds the using sum of the user, and thereby the settlement with the electronic money can be made by off-line processing without interrogating the electronic money settling server which is located on the network such as the Internet. Because of this, it is possible to eliminate the need for an on-line facility provided in the shop terminal for connecting with the network, and diversify the usage of the shop terminal.

In the invention as described above, it is preferred that, only when the amount of electronic money to be accepted is not greater than a predetermined credit limit, the shop terminal accepts this amount of electronic money. In this case, it is possible to set the limit to the usage amount of the user and thereby minimize the chance of trouble that may arise in conjunction with off-line electronic money settlement.

Incidentally, in the invention as described above, it is preferred that the authentication information is the fingerprint information of a store manager. In addition, in the invention as described above, it is preferred that while storing in the shop terminal the authentication information stored in said shop card, the authentication information stored in said shop terminal is compared to the authentication information stored in said shop card, and only when they match, the deposits and withdrawals of electronic money are made. In this case, it is possible to perform the identity verification of the manager of the store and the confirmation of the validity of the shop card, allow only the manager to cash the electronic money stored in said shop terminal, and surely prevent troubles from arising in conjunction with electronic money settlement.

Still further, in accordance with the above invention, it is possible at a settling server which is located on the Internet to perform an authentication process on the basis of said authentication information of said shop card, and enable encashment of electronic money corresponding to the amount electronic money stored in said shop card. In this case, when electronic money is cashed, it is possible to perform on-line authentication at a financial institution or an ATM device, and prevent troubles from arising in conjunction with encashment of electronic money.

### BRIEF DESCRIPTION OF THE DRAWINGS

FIG. 1 is a view for showing the overall configuration of the system in accordance with an embodiment.

FIG. 2 is a block diagram for showing the shop terminal in accordance with the embodiment.

FIG. 3 is a sequence diagram for showing the operation of the system in accordance with the embodiment.

FIG. 4 is an explanatory view for showing the procedure of issuing a card in accordance with the embodiment.

### BEST MODE FOR CARRYING OUT THE INVENTION

(Overall Configuration of System)

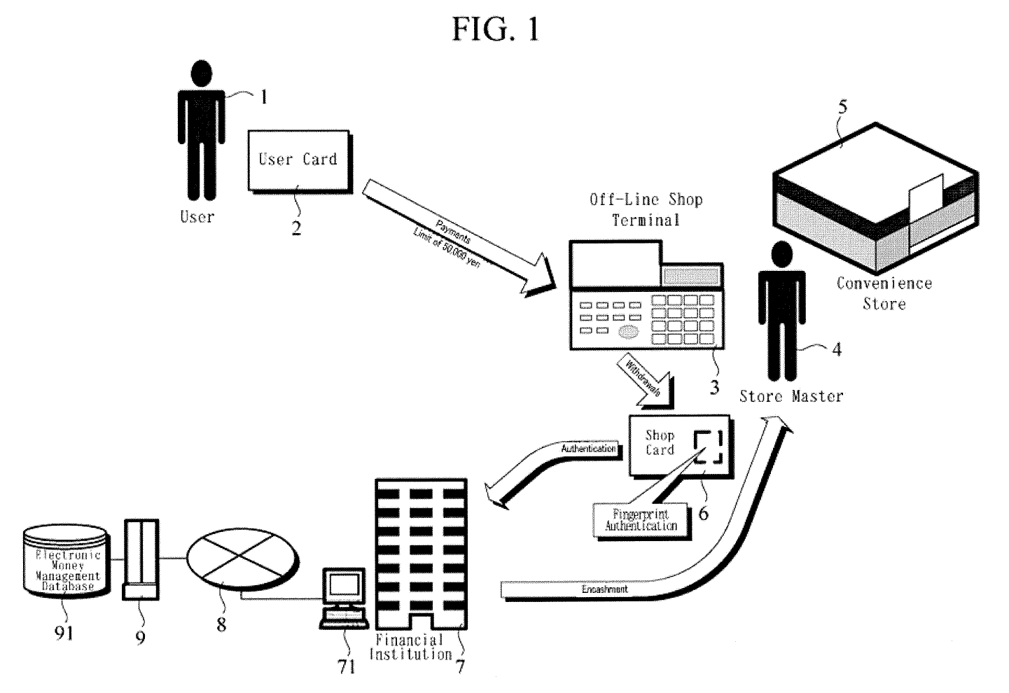

An embodiment of the present invention will be explained with reference to drawings. FIG. 1 is an explanatory view for schematically showing the configuration of an electronic money settling system in accordance with the present embodiment. The present embodiment will be explained in the exemplary case where a user 1 shops or the like and make payments in a convenience store 5.

The users 1 possesses a user card 2. This user card 2 is a card in which are implemented a radio IC tag such a RFID tag, a memory and the like, and provided with the functionality of accumulating electronic money in the memory and making deposits and withdrawals of electronic money through the radio IC tag. The radio IC tag is capable of transmitting an ID which is unique to each card through radio waves as an ID signal, and composed of a small-sized IC chip and an antenna made of a metal. Incidentally, the RFID tag is of a type which makes use of a built-in power source such as a battery and actively transmits an information signal from an RF tag, or a type which transmits an information signal by the use of the electric current induced in response to electromagnetic waves output from an antenna at the receiver side.

In the convenience store 5, there is installed a shop terminal 3 which is managed by a manager such as the shop master 4. The shop master 4 possesses a shop card 6.

This shop card 6 is implemented with a radio IC tag and a memory in the same manner as the user card 2, and provided with the functionality of authenticating the user (shop master 4) with reference to fingerprint information. Then, only when the authentication is successfully completed with the fingerprint authentication information of the shop master 4, this shop card 6 can be used to make deposits and withdrawals of electronic money through the shop terminal 3.

The shop terminal 3 is, for example, a cash register which is installed in the store and provided with the capability of settling electronic money on the basis of the present invention in addition to the capability of calculating the using expense of the user 1 and performing the management of money. In other words, the shop terminal 3 is provided with the functionality required of an electronic money management device, i.e., the functionality of making the settlement of electronic money without a need for authentication in a server or the like on the network, and serves to acquire the amount of electronic money stored in the user card 2 and accept the electronic money corresponding to the using sum associated with the settlement when the amount of electronic money stored in the user card 2 is greater than the using sum as long as the using sum is no smaller than the credit limit. The specific configuration of this shop terminal 3 will be described below.

On the other hand, the electronic money stored in the shop card 6 is handled by an electronic money settling server 9 accessible through the Internet 8. This electronic money settling server 9 is provided with an electronic money management database 91 and serves to accumulate and manage the fingerprint information equivalent to the fingerprint information stored in the respective shop cards, perform authentication on the basis of the fingerprint information in response to a request from a financial institution 7 or the like for making the settlement such as encashment, and change the electronic money stored in the shop card 6 into cache through the financial institution 7. The financial institution 7 or the like can ask the electronic money settling server 9 to perform the authentication process required for making settlement such as encashment through a terminal 71 or the like used by the financial institution 7. Meanwhile, this terminal 71 may be an ATM service terminal which is installed in the financial institution or the convenience store, or at curbside.

(Configuration of the Store Terminal 3)

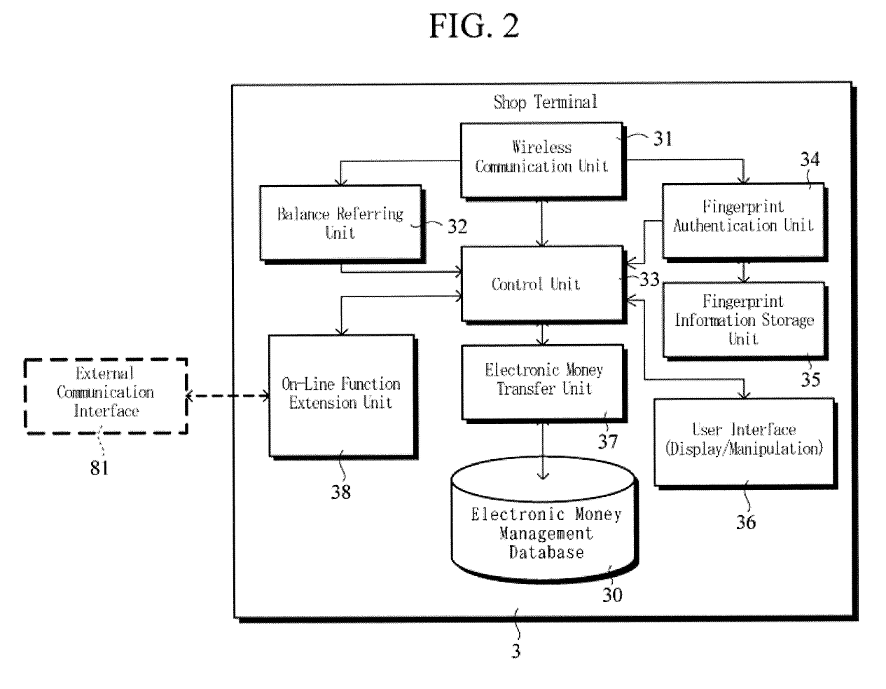

FIG. 2 is a block diagram for showing the internal configuration of the shop terminal 3.

As shown in the same figure, the shop terminal 3 is provided with a radio communication unit 31, a balance referring unit 32, a fingerprint authentication unit 34, an electronic money transfer unit 37, a user interface 36 and a control unit 33 for controlling the respective units.

The radio communication unit 31 is a noncontact communication device serving to perform noncontact communication with the user card 2 and the shop card 6, and capable of starting radio communication and transmitting and receiving data to/from the card by holding the user card 2 or the shop card 6 over the radio communication unit 31 at close hand.

The balance referring unit 32 is a module for confirming the balance of the electronic money stored in the user card 2 and whether or not the card is solvent, when electronic money is accepted from the user card 2. In addition, only when the amount of electronic money to be accepted is no greater than a predetermined credit limit, the balance referring unit 32 serves also as a determination unit which accept the corresponding amount of electronic money.

The fingerprint authentication unit 34 is a module which is connected to a fingerprint information storage unit 35 and serves to perform the authentication of the fingerprint information of the shop master 4 stored in the shop card 6. More specifically speaking, the fingerprint information stored in the fingerprint information storage unit 35 is compared to the fingerprint information stored in the shop card 6, and only when they match, the deposits and withdrawals of electronic money is made by the electronic money transfer unit 37.

The electronic money transfer unit 37 is a module for accepting electronic money through the radio communication unit 31. When electronic money is actually accepted, the electronic money transfer unit 37 reduces the amount of electronic money stored in a card which is the communication partner and increase the amount of electronic money stored in an electronic money accumulating unit 30 when accepting electronic money. On the other hand, when electronic money is actually transferred to the card, the electronic money transfer unit 37 increase the amount of electronic money stored in the card and reduce the amount of electronic money stored in the electronic money accumulating unit 30.

Meanwhile, the control unit 33 is connected to the user interface 36 such as a display unit and a manipulation unit, and serves to display predetermined information to the user and receive a manipulation signal. In addition, the control unit 33 is connected to an on-line function extension unit 38, and thereby it is possible to add an on-line capability to the shop terminal 3 for connecting an external communication interface 81 or the like if necessary.

(Electronic Money Settling Method)

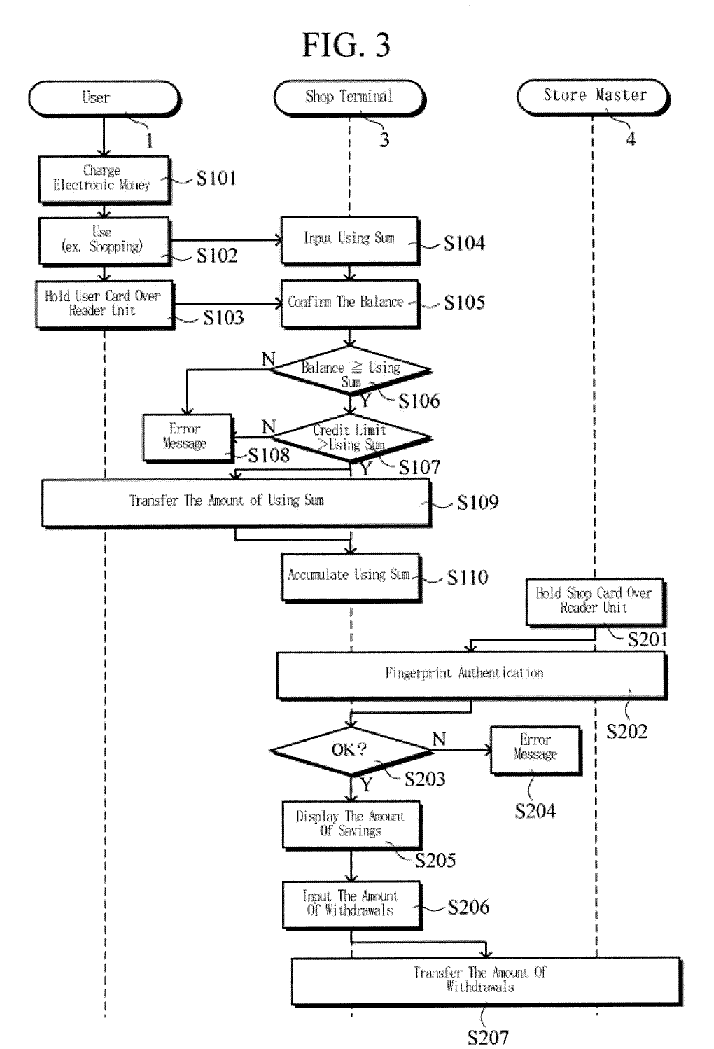

The electronic money settling method in accordance with the present invention can be made by operating the electronic money settling system having the structure as described above. FIG. 3 is a flow chart for showing the operation of the system in accordance with the present embodiment.

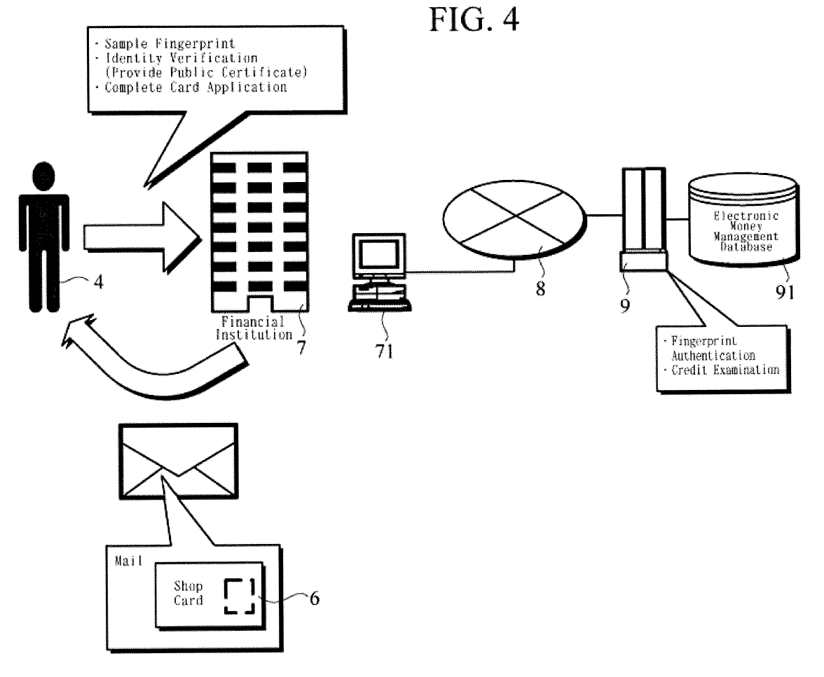

In the case of the present embodiment, as illustrated in FIG. 4, it is assumed that the fingerprint of the shop master 4 has been registered at the electronic money management database 91 by performing credit examination after sampling a fingerprint information and performing identity verification for shop card application in advance at the financial institution 7 of the shop master 4, and then the shop card 6 has been forwarded to the shop master 4.

First, electronic money is stored (charged) in the user card 2 in step S101. The user 1 makes a purchase or the like in the convenience store 5 in step S104, and makes payment at a cash register. When making payment for the shopping, the using sum of the user 1 is input to the shop terminal 3 on the store side in step S104, and the user 1 is asked to provide the user card 2.

At this request, the user 1 holds the user card 2 over a reader unit of the shop terminal 3 in step S103. By this procedure, the shop terminal 3 acquires the card ID of the user card 2 and confirm the balance and the using sum in steps S105 to S107. Specifically speaking, it is determined whether or not the using sum exceeds the balance and whether or not the using sum exceeds the credit limit. If the using sum exceeds the balance or the credit limit, an error message is displayed and the process is canceled in step S108.

When it is determined that the using sum does not exceed the balance or the credit limit in step S106 and S107, the amount of electronic money corresponding to the using sum is transferred from the user card 2 to the shop terminal 3 in step S109, and accumulated in the electronic money accumulating unit 30 in step S110.

In this way, while payment by users is repeated, electronic money is accumulated in the shop terminal 3. Then, if the shop master 4 wishes encashment of the electronic money accumulated in the shop terminal 3, the following steps are performed.

First, the shop master 4 holds the shop card 6 over the reader unit of the shop terminal 3 in step S201. By this procedure, the shop terminal 3 acquires the card ID of the shop card 6, and determines that the card as held is the shop card. The shop terminal 3 then performs the authentication of the fingerprint information stored in the shop card 6 in steps S202 and S203. More specifically speaking, the fingerprint information stored in the shop terminal 3 is compared to the fingerprint information stored in the shop card 6, and it is confirmed whether or not they match. If they do not match, an error message is displayed and the process is cancelled in step S204.

If it is determined in step S203 that the fingerprint information matches, while displaying the amount of savings (possible amount of withdrawals) as accumulated in the electronic money accumulating unit 30 in step S205, the shop master 4 is asked to input the desired amount of withdrawals, and in accordance with the amount of withdrawals as input in step S206 the electronic money corresponding to the amount of withdrawals is transferred from the electronic money accumulating unit 30 to the shop card 6 in step S207.

In this way, the electronic money transferred to the shop card 6 can be converted into cash at the financial institution 7 or the like. In other words, the shop master 4 can receive payment of the corresponding cash by bringing the shop card 6 to the financial institution 7, performing the fingerprint authentication of the shop master 4 at the financial institution 7, reducing the amount of the electronic money stored in the shop card 6 if appropriate. In this encashment procedure, the financial institution 7 or the like can ask the electronic money settling server 9 to perform the authentication of fingerprint information through the terminal 71 which is used by itself. In other words, after the fingerprint information stored in the electronic money management database 91, the fingerprint information of the shop master 4 sampled at the financial institution 7 and the fingerprint information stored in the shop card 6 are transmitted, the electronic money settling server 9 matches each fingerprint information against another in order to perform identity verification of the shop master 4, determine the validity of the shop card 6, and notify the financial institution 7 of the result thereof. The financial institution 7 performs encashment on the basis of this notification.

(Action/Effect)

In accordance with the present embodiment as has been discussed above, when the user 1 makes payment, it is determined only whether or not the balance of the user card 2 exceeds the using sum of the user 1, and thereby the settlement with the electronic money can be made by off-line processing without interrogating the electronic money settling server 9 which is located on the network such as the Internet 8. Because of this, it is possible to eliminate the need for an on-line facility provided in the shop terminal 3 for connecting with the network, and diversify the usage of the shop terminal.

In the above embodiment, only when the amount of electronic money to be accepted is not greater than a predetermined credit limit, the shop terminal 3 accepts electronic money corresponding to this amount, and thereby it is possible to set the limit to the usage amount of the user 1 and minimize the chance of trouble that may arise in conjunction with off-line electronic money settlement.

Meanwhile, in the case of the above embodiment, while storing in the shop terminal 3 the information equivalent to the fingerprint information stored in the shop card 6, the fingerprint information stored in the shop terminal 3 is compared to the fingerprint information stored in the shop card 6, and only when they match, the deposits and withdrawals of electronic money are made, so that it is possible to perform the identity verification of the master of the convenience store 5 and the confirmation of the validity of the shop card 6, allow only the shop master 4 to cash electronic money, and surely prevent troubles from arising in conjunction with off-line electronic money settlement.

### INDUSTRIAL APPLICABILITY

As has been discussed above, in accordance with the present invention, the off-line settlement with the electronic money can be made even under the circumstances such as an automatic vendor or an outdoor shop, where on-line facilities are hard to install.

What is claimed is:

1. An electronic money settling system for making settlement with electronic money, comprising:
a user card operable to accumulate electronic money;
a shop terminal operable to acquire the amount of electronic money stored in said user card, and accept the electronic money corresponding to the using sum associated with the settlement if the amount of electronic money stored in said user card is not greater than the using sum; and
a shop card operable to store predetermined authentication information, and enable said shop terminal to deposit and withdraw electronic money only when the authentication is completed on the basis of the authentication information.

2. The electronic money settling system as claimed in claim 1 wherein, only when the amount of electronic money to be accepted is not greater than a predetermined credit limit, said shop terminal accepts this amount of electronic money.

3. The electronic money settling system as claimed in claim 1 wherein said authentication information is the fingerprint information of the store manager.

4. The electronic money settling system as claimed in claim 1 wherein said shop terminal is provided with an authentication information storage unit operable to store the authentication information stored in said shop card, and
wherein the authentication information stored in said authentication information storage unit is compared to the authentication information stored in said shop card, and only when they match, the deposits and withdrawals of electronic money are made.

5. The electronic money settling system as claimed in claim 1 further comprising a settling server which is located on the Internet and serves to perform an authentication process on the basis of said authentication information of said shop card, and enable encashment of electronic money corresponding to the amount electronic money stored in said shop card.

6. An electronic money settling method for making settlement with electronic money, comprising:
a step (1) of accumulating electronic money in a user card which is used by a user;
a step (2) of acquiring the amount of electronic money stored in said user card, accepting the electronic money corresponding to the using sum associated with the settlement if the amount of electronic money stored in said user card is not greater than the using sum, and accumulating the electronic money as accepted, said step (2) being performed by a shop terminal; and
a step (3) of storing predetermined authentication information in the shop card, and enabling said shop terminal to deposit and withdraw electronic money only when authentication is completed on the basis of the authentication information.

7. The electronic money settling method as claimed in claim 6 wherein, in said step (2), only when the amount of electronic money to be accepted is not greater than a predetermined credit limit, this amount of electronic money is accepted.

8. The electronic money settling method as claimed in claim 6 wherein said authentication information is the fingerprint information of the store manager.

9. The electronic money settling method as claimed in claim 6 wherein, in the step (3), while storing in a shop terminal the authentication information stored in said shop card, the authentication information stored in said shop terminal is compared to the authentication information stored in said shop card, and only when they match, the deposits and withdrawals of electronic money are made.

10. The electronic money settling method as claimed in claim 6 further comprising a step of performing an authentication process on the basis of said authentication information of said shop card, and enabling encashment of electronic money corresponding to the amount electronic money stored in said shop card, this step being performed by a settling server which is located on the Internet.
